(19) United States
(12) Patent Application Publication
(10) Pub. No.: US 2008/0308699 A1
(43) Pub. Date: Dec. 18, 2008

(54) Tilting apparatus and rotation apparatus

(75) Inventors: Jae-Kyung Kim, Ansan-si (KR); Chil-Sung Lee, Suwon-si (KR); Kyoung-Shin Park, Suwon-si (KR); Jun-Sup Shin, Seongnam-si (KR); Jae-Hun Kim, Suwon-si (KR); Dong-Won Choi, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/213,113

(22) Filed: Jun. 13, 2008

(30) Foreign Application Priority Data
Jun. 13, 2007 (KR) 10-2007-0057803

(51) Int. Cl. F16M 13/00

(52) U.S. Cl. 248/274.1

(57) ABSTRACT

A tilting apparatus and rotation apparatus. The tilting apparatus may include a support member, a tilt member attachable to and detachable from a mass and hinge-coupled to the support member about a hinge shaft, and a first elastic member interposed between the support member and the tilt member that counters a gravitational moment of the mass by elastically supporting the tilt member. The mass can be moved and rotated without being obstructed by the wall, while the gravitational moment of the mass can be countered, allowing the mass to be tilted with a small force, to provide benefits in terms of space utility and cost.

The force provided by an elastic member can be adjusted according to the dimensions of the mass, so that a mass of various dimensions can be tilted without having to replace the elastic member, allowing the tilting apparatus to be manufactured in a modularized form.

### CROSS-REFERENCE TO RELATED APPLICATIONS

This application claims the benefit of Korean Patent Application No. 10-2007-0057803 filed with the Korean Intellectual Property Office on Jun. 13, 2007, the disclosure of which is incorporated herein by reference in its entirety.

### BACKGROUND

1. Technical Field

The present invention relates to a tilting apparatus and a rotation apparatus.

2. Description of the Related Art

Flat panel displays, such as TV sets and monitors, employing LCD, PDP, LED technology, etc., provide the benefit of allowing efficient use of small spaces, and are fast replacing Braun tube TV's and monitors. The increase in demand for such flat panel displays is expected to continue into the future. However, due to the thin thicknesses of these flat panel displays, it is difficult to have a flat panel display stand by itself, and thus mounting devices are being developed which allow flat panel displays to be mounted on walls.

The conventional device for mounting a flat panel display on a wall, however, simply affixes the display onto the wall, so that when a user changes one's position, the optimal viewing angle cannot be maintained.

Also, while the wall and the display have to be separated by a certain distance, if the display is to be rotated in a desired direction without being obstructed by the wall, the conventional mounting device provides little or no gap between the display and the wall. This makes it difficult to change the position of the display, and even if an additional member is joined on to separate the display from the wall, the display would protrude outward from the wall because of the additional member. This can undermine the benefits of the flat panel display, such as of elegant appearance and efficiency in utilizing indoor space, which originate from the characteristic of the flat panel display that it is in close contact with the wall.

Also, when automatically tilting a mass such as a display, etc., an appropriate power source is required according to the weight of the mass. However, for a large display, the weight of which can be over 40 kg, a large capacity power source may be required for tilting the display, which can impose additional space limitations and increase cost.

### SUMMARY

An aspect of the invention is to provide a tilting apparatus and rotation apparatus, which can rotate a mass such as a display in a desired direction without obstruction by the wall, to maintain an optimal viewing angle.

Another aspect of the invention is to provide a tilting apparatus and a rotation apparatus, which can mitigate the gravitational moment of the mass, so that the mass can be tilted with a small driving force.

Also, one aspect of the invention is to provide a tilting apparatus and a rotation apparatus, in which the elastic force applied by an elastic member can be adjusted according to the weight of the mass, in cases where an elastic member is used to mitigate the gravitational moment of the mass, so that masses of various dimensions can be tilted without having to replace the elastic member.

One aspect of the invention provides a tilting apparatus tiltably supporting a mass. The tilting apparatus may include a support member, a tilt member attachable to and detachable from the mass and hinge-coupled to the support member about a hinge shaft, and a first elastic member interposed between the support member and the tilt member and configured to counter a gravitational moment of the mass by elastically supporting the tilt member.

The first elastic member can be such that the elastic force provided by the first elastic member is adjustable.

The first elastic member can be a compression coil spring, where one end of the compression coil spring can be coupled to the tilt member.

The tilting apparatus may further include a second elastic member, which may provide an elastic force in a direction opposing the gravitational moment of the mass. The second elastic member can be such that the elastic force provided by the second elastic member is adjustable.

In certain embodiments, a driving unit may additionally be included, which may provide a driving force that tilts the tilt member.

Another aspect of the invention provides a rotation apparatus, which rotatably supports a mass, and which can move the mass to a predetermined position. The rotation apparatus may include a fixed body, a link member that has one end hinge-coupled to the fixed body, a connecting piece hinge-coupled to the other end of the link member, and a tilting apparatus attachable to and detachable from the connecting piece, where the tilting apparatus may include a support member detachably attached to the connecting piece, a tilt member attachable to and detachable from the mass and hinge-coupled to the support member about a hinge shaft, and a first elastic member interposed between the support member and the tilt member and configured to counter a gravitational moment of the mass by elastically supporting the tilt member.

The first elastic member can be such that the elastic force provided by the first elastic member is adjustable.

The first elastic member can be a compression coil spring, where one end of the compression coil spring can be coupled to the tilt member.

The rotation apparatus may further include a second elastic member, which may provide an elastic force in a direction opposing the gravitational moment of the mass. The second elastic member can be such that the elastic force provided by the second elastic member is adjustable.

In certain embodiments, a driving unit may additionally be included, which may provide a driving force that tilts the tilt member.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a diagram of a tilting device according to an embodiment of the invention.

FIG. 2 is a diagram of a structure of the elastic member for adjusting elastic force according to an embodiment of the invention.

FIG. 3 is a diagram of a rotation device according to an embodiment of the invention.

### DETAILED DESCRIPTION

The tilting apparatus and rotation apparatus according to certain embodiments of the invention will be described below in more detail with reference to the accompanying drawings. Those components that are the same or are in correspondence are rendered the same reference numeral regardless of the figure number, and redundant explanations are omitted.

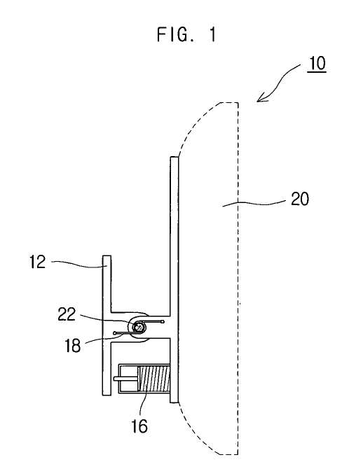

FIG. 1 is a diagram of a tilting device according to an embodiment of the invention. In FIG. 1 are illustrated a tilting apparatus 10, a support member 12, a tilt member 14, a first elastic member 16, a hinge shaft 18, a second elastic member 22, and a mass 20.

A tilting apparatus 10 according to this embodiment can include a support member 12, a tilt member 14 attachable to and detachable from a mass 20 and hinge-coupled to the support member 12 about a hinge shaft 18, and a first elastic member 16 interposed between the support member 12 and the tilt member 14 and configured to counter a gravitational moment of the mass 20 by elastically supporting the tilt member 14. With this configuration, a mass 20 having a particular weight from among a wide range of values can be tiltably supported, i.e. supported in a manner that allows the mass 20 to tilt, and tilted to a particular inclination, without having to replace the elastic member.

The mass 20 used with a tilting apparatus 10 based on this embodiment can be a Braun tube TV set or monitor, or a flat panel display. Of course, any of various masses 20 that requires tilting adjustment, other than a type of display, can also be used.

The support member 12 can be the element that secures the tilting apparatus 10 according to this embodiment in a predetermined position, while the tilt member 14 can be the element to which the mass 20, e.g. a display, etc., may be coupled. Thus, by rotating the tilt member 14, the upward/downward inclination angle of the mass 20 can be adjusted. The mass 20, such as a display, etc., can be attached to and detached from the tilt member 14, so that a mass 20 having various dimensions can be coupled. The support member 12 may secure the tilting apparatus 10 by itself to a fixed position such as a wall, etc., or may secure the tilting apparatus 10 by way of the later described rotation apparatus, to enable tilting for the mass 20, e.g. a display.

The tilt member 14 may be hinge-coupled to the support member 12 about a hinge shaft 18, to allow upward/downward tilting of the mass, e.g. a display, about the hinge shaft 18.

The first elastic member 16 may be interposed between the support member 12 and the tilt member 14 and, when a mass 20 is coupled to the tilt member 14, may elastically support the tilt member 14 in a manner that counters the gravitational moment of the mass 20. Here, the first elastic member 16 may provide an adjustable elastic force, to respond to masses 20 having different weights. That is, when a mass 20 having a different weight is attached onto the tilt member 14, the elastic force may have to be changed, in order to adequately counter the corresponding gravitational moment. The changing of the elastic force can be achieved by replacing the elastic member or by adjusting the elastic force provided by the elastic member. However, having to replace the elastic member may present problems in modularizing the tilting apparatus 10. As such, by having the elastic force be adjustable in accordance with the weight of the mass 20 attached to the tilt member 14, the tilting apparatus 10 can be manufactured in a modularized form, without replacing the elastic member.

The gravitational moment is the moment applied to the hinge shaft 18 by the weight of the mass 20. The weight of the mass 20 may apply a force in the gravitational direction, and a moment is applied which is obtained by multiplying this force by the distance between the hinge shaft 18 and the center of gravity of the mass 20. (Here, the weight of the tilting apparatus itself is not considered, for convenience in describing the spirit of the invention.)

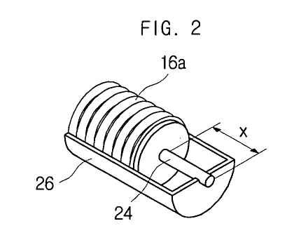

When automatically tilting a mass 20, such as a display, etc., a power source of a large capacity may be required, if the mass 20 is to be rotated against the moment produced by the entire weight of the mass 20, and this may incur spatial limitations and may increase costs. Thus, as in the example illustrated in FIG. 1, the first elastic member 16 may be coupled onto a lower portion of the tilt member 14 in relation to the hinge shaft 18, to elastically support the tilt member 14 and thereby oppose the rotation caused by the gravitational moment of the mass 20 attached to the tilt member 14 about the hinge shaft 18 (in FIG. 1, the clockwise rotation about the hinge shaft). With the first elastic member 16 thus elastically supporting the tilt member 14 to counter the gravitational moment of the mass 20, the mass 20 may be tilted with a power source having a smaller capacity. In this case, the elastic force provided by the first elastic member 16 can be adjusted in accordance with the weight of the mass 20 attached to the tilt member 14, to respond to masses 20 having various weights. The composition for adjusting the elastic force provided by the first elastic member 16 will be described in more detail with reference to FIG. 2.

This embodiment has been described for a particular example in which a compression coil spring 16a is used for the first elastic member 16, with the first elastic member 16 coupled to a portion of the tilt member 14 lower than the hinge shaft 18. Other examples, however, may employ a torsion spring for the first elastic member 16, which has one end coupled to a portion of the tilt member 14 above the hinge shaft 18 and the other end coupled to the support member 12, to elastically support the tilt member 14 and oppose the rotation of the tilt member 14 that may otherwise be caused by the gravitational moment of the mass 20 attached to the tilt member 14.

In addition, a second elastic member 22 may also be included on the tilt member 14 that provides an elastic force opposing the gravitational moment of the mass 20. This second elastic member 22 may also be such that provides an adjustable elastic force.

By using multiple elastic members, as described above, it is possible to fine-tune the elastic forces provided, and thereby respond to masses 20 having various weights. For example, assuming the case where the tilting apparatus 10 is modularized to accommodate a mass 20 having a weight of 20 to 40 kg and where the distance from the hinge shaft 18 to the center of gravity of the mass 20 is 10 cm, the gravitational moment generated for a mass 20 having a minimum weight of 20 kg will be 200 kg·cm, and the gravitational moment generated for a mass 20 having a maximum weight of 40 kg will be 400 kg·cm. Thus, to effectively counter the gravitational moment and tilt the mass 20 with a small-capacity power source, a moment of about 200 kg·cm, for a mass 20 of minimum weight 20 kg, and a moment of about 400 kg·cm, for a mass 20 of maximum weight 40 kg, may be needed from the elastic force. If, for example, the first elastic member 16 is used to preliminarily counter the gravitational moment up to 200 kg·cm, the elastic force of the second elastic member 22 can be adjusted to provide a moment of about 0 to 200 kg·cm, so that the tilting apparatus 10 may be modularized to accommodate a mass 20 ranging from 20 kg to 40 kg. That is, for a mass 20 weighing 20 kg, the second elastic member 22 can be adjusted not to provide an elastic force, and for a mass 20 weighing 30 kg, the second elastic member 22 can be adjusted to counter the remaining 100 kg·cm. For a mass 20 weighing 40 kg, the second elastic member 22 can be adjusted to counter the remaining 200 kg·cm. In this way, by having a first elastic member 16 counter a predetermined amount of gravitational moment and adjusting a second elastic member 22 to counter the remaining moment, it is possible to fine-tune the elastic forces provided and respond to masses 20 having various dimensions, without requiring a large force. This embodiment has been described for a particular example of fixing the amount of elastic force provided by a first elastic member 16 and adjusting the amount of elastic force provided by a second elastic member 22. It is to be appreciated, however, that other examples may employ various other combinations in methods of adjusting the elastic forces provided by the first and second elastic members 16, 22, to counter the gravitational moment provided by masses 20 of various dimensions.

A driving unit (not shown) may provide a driving force that tilts the tilt member 14 to which the mass 20 may be attached and detached, where various forms of the driving unit may be employed that are capable of rotating the tilt member 14. For example, in cases where the tilt member 14 is secured to the hinge shaft 18, a driving unit equipped with a motor can be coupled to the hinge shaft 18 to rotate the tilt member 14 upwards or downwards by rotating the hinge shaft 18 in forward/reverse directions. In cases where the tilt member 14 is not secured to the hinge shaft 18, a driving unit may be employed that is able to convert the rotations of a motor into linear motions, whereby the tilt member 14 can be made to rotate about the hinge shaft 18 by pulling an upper or lower portion of the tilt member 14.

FIG. 2 is a diagram of a structure of the elastic member for adjusting elastic force according to an embodiment of the invention. In FIG. 2 are illustrated a compression coil spring 16a, a supporting piece 24, and a guide part 26.

As described above, the first elastic member can be placed between the support member and the tilt member to elastically support the tilt member in a manner countering the gravitational moment of the mass, when a mass is coupled to the tilt member. This first elastic member can be a compression coil spring 16a, which is a spring that elastically supports against a compressive force. One end of the compression coil spring 16a can be coupled to a lower portion of the tilt member to elastically support the tilt member in such a way that counters the gravitational moment of the mass. One end of the compression coil spring 16a may thus be coupled to the tilt member, and as the tilt member is rotated by the weight of the mass, the other end of the compression coil spring 16a may be supported by the support member to elastically support the tilt member.

While this embodiment is described for the example in which the compression coil spring 16a has one end coupled to the tilt member and the other end coupled to the support member, it is possible to conversely couple the one end of the compression coil spring 16a to the support member and have the other end elastically support the tilt member.

In cases where a compression coil spring 16a is used for the first elastic member, it is possible to adjust the elastic force applied by the compression coil spring 16a. To adjust the elastic force of the compression coil spring 1 6a in this embodiment, a guide part 26 may be used, such as that illustrated in FIG. 2, where the compression coil spring 16a may be held in the guide part 26 so that the elastic compression of the compression coil spring 16a may be guided. In FIG. 2, only a portion of the cylindrically shaped guide part 26 is illustrated, to show the inside of the guide part 26. When the assembly of the first elastic member is complete, the remaining portions of the guide part 26 may enclose the inside of the guide part 26, such that the compression coil spring 16a may be held within. One side of the cylindrical guide part 26 can be coupled to the tilt member, while a hole may be formed in the other side, so that a protruding portion of a supporting piece 24 may be exposed through the hole to elastically support the tilt member. A flange may be formed on one side of the supporting piece 24 facing one side of the compression coil spring 16a, so that a substantially uniform amount of compressive force may be applied over the surface of the compression coil spring 16a.

The elastic force (F) of an elastic member can be represented as a multiple of the elastic coefficient (K) of the elastic member and the displacement (X) of the elastic member, as shown below in [Equation 1].

F=K·X [Equation 1]

In order to counter the gravitational moment of a mass, for masses having various weights, it may be necessary to adjust the elastic force. In this embodiment, the adjusting of the elastic force can be achieved by adjusting the displacement of the compression coil spring 16a beforehand. In other words, as in the example illustrated in FIG. 2, the position of the supporting piece 24 (denoted by X in FIG. 2) may be adjusted to adjust the elastic force obtained. As the position of the supporting piece 24 is set beforehand, the displacement of the supporting piece 24 is known, with the total displacement becoming the sum of the displacement of the supporting piece 24 and the displacement from the elastic compression caused by the gravitational moment of the mass. Using this total displacement, the elastic force generated in the compression coil spring 16a can be calculated, which may be used to counter the gravitational moment of the mass and elastically support the tilt member.

A coil-shaped torsion spring may also be used for the second elastic member. For example, a hinge shaft can be inserted through a torsion coil spring to limit the movement of the torsion spring. Then, one end of the torsion spring can be coupled to the support member, and an amount of torsion may be applied such that the torsion spring will be made to deliver an elastic force in a direction opposing the gravitational moment of the mass, after which the other end can be coupled to the tilt member, to elastically support the tilt member. In this case, the movement of the torsion spring can be limited by the hinge shaft, whereby an elastic force may be delivered to the tilt member in a stable manner. It is possible to adjust the elastic force provided by this second elastic member also. The elastic force of a torsion spring can be adjusted by coupling one end of the torsion spring to the support member, adjusting the amount of torsion in the torsion spring, and then coupling the other end to the tilt member.

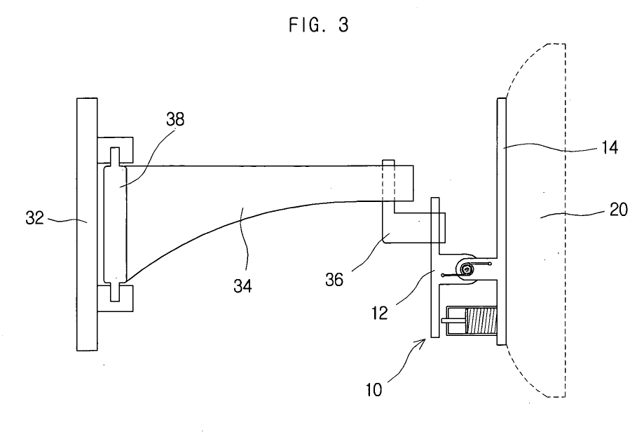

FIG. 3 is a diagram of a rotation device according to an embodiment of the invention. In FIG. 3 are illustrated a tilting apparatus 10, a support member 12, a tilt member 14, a mass 20 a fixed body 32, a link member 34, and a connecting piece 36.

The rotation apparatus according to this embodiment can include a fixed body 32, a link member 34 that has one end hinge-coupled to the fixed body 32, a connecting piece 36 hinge-coupled to the other end of the link member 34, and a tilting apparatus 10 attachable to and detachable from the connecting piece 36. With this configuration, the rotation apparatus may rotatably support a mass 20 and move the mass 20 to a particular position.

The rotation shafts in the hinge joints at either side of the link member 34 can be substantially parallel to each other and can be substantially perpendicular to the hinge shaft 18 of the tilting apparatus 10, to not only allow the tilt member 14 to move in a translational motion with respect to the fixed body 32 but also allow the tilt member 14 to rotate in left, right, upward, and downward directions.

In the rotation apparatus of this particular embodiment, the fixed body 32 can be secured to a wall, etc., and a mass 20 such as a display, etc., can be secured to the tilt member 14. In this way, the tilt member 14 can manually or automatically be moved in a translational motion or be rotated in the left, right, upward, and downward directions, to move the mass 20 in a direction desired by the user. If the mass 20 is a display, such as an LCD or PDP, etc., the front of the display 40 can be made to face a direction desired by the user, to thereby provide an optimal viewing angle.

The support member 12 of the tilting apparatus 10 may be secured to the connecting piece 36, whereby the tilt member 14 may rotate upwards or downwards about the hinge shaft relative to the support member 12.

Looking at the method of operating a rotation apparatus according to this embodiment, the link member 34 may be rotated about the fixed body 32, due to the hinge joint between one end of the link member 34 and the fixed body 32, and thus the tilt member 14 coupled to the other end of the link member 34 may move in a translational motion relative to the fixed body 32. Also, the hinge joint between the other end of the link member 34 and the connecting piece 36 allows the tilt member 14 to be rotated left and right, while the tilting apparatus 10 detachably coupled to the connecting piece 36 allows the tilt member 14 to be rotated upwards and downwards.

The tilting apparatus 10 can be attached to or detached from the rotation apparatus according to the dimensions of the mass 20, e.g. display, etc., and the environment or requirements of the consumer. If the user does not wish to use the tilting function for the mass 20, e.g. display, the manufacturer can provide a rotation apparatus without the tilting function, in which case the rotation apparatus may offer only the translational movement and left/right rotation functions. If the user does wish to use the tilting function, the tilting apparatus 10 can be provided with the rotation apparatus attached, to cater for the preferences of the user.

The components of the tilting apparatus 10 can be substantially the same as those of the previously described embodiment, and thus a description of the components will not be repeated.

By utilizing certain embodiments of the invention as set forth above, a mass such as a display, etc., can be moved and rotated without being obstructed by the wall, while the gravitational moment of the mass can be countered such that the mass can be tilted with a small force. As such, certain embodiments of the invention may provide benefits in terms of space utility and cost.

Also, the elastic forces provided by one or more elastic members can be adjusted according to the dimensions of the mass, making it possible to tilt a mass of a variety of dimensions without having to replace the elastic members. Thus, the tilting apparatus can be manufactured in a modularized form.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention. As such, many embodiments other than those set forth above can be found in the appended claims.

What is claimed is:

1. A tilting apparatus tiltably supporting a mass, the tilting apparatus comprising:
a support member;
a tilt member attachable to and detachable from the mass and hinge-coupled to the support member about a hinge shaft; and
a first elastic member interposed between the support member and the tilt member and configured to counter a gravitational moment of the mass by elastically supporting the tilt member.

2. The tilting apparatus of claim 1, wherein an elastic force provided by the first elastic member is adjustable.

3. The tilting apparatus of claim 1, wherein the first elastic member is a compression coil spring,
and wherein the compression coil spring has one end thereof coupled to the tilt member.

4. The tilting apparatus of claim 1, further comprising:
a second elastic member providing an elastic force in a direction opposing the gravitational moment of the mass.

5. The tilting apparatus of claim 4, wherein the elastic force provided by the second elastic member is adjustable.

6. The tilting apparatus of claim 1, further comprising:
a driving unit configured to provide a driving force such that the tilt member is tilted.

7. A rotation apparatus rotatably supporting a mass and configured to move the mass to a predetermined position, the rotation apparatus comprising:
a fixed body;
a link member having one end thereof hinge-coupled to the fixed body;
a connecting piece hinge-coupled to the other end of the link member; and
a tilting apparatus attachable to and detachable from the connecting piece, wherein the tilting apparatus comprises:
a support member detachably attached to the connecting piece;
a tilt member attachable to and detachable from the mass and hinge-coupled to the support member about a hinge shaft; and
a first elastic member interposed between the support member and the tilt member and configured to counter a gravitational moment of the mass by elastically supporting the tilt member.

8. The rotation apparatus of claim 7, wherein an elastic force provided by the first elastic member is adjustable.

9. The rotation apparatus of claim 7, wherein the first elastic member is a compression coil spring,
and wherein the compression coil spring has one end thereof coupled to the tilt member.

10. The rotation apparatus of claim 7, further comprising:
a second elastic member providing an elastic force in a direction opposing the gravitational moment of the mass.

11. The rotation apparatus of claim 10, wherein the elastic force provided by the second elastic member is adjustable.

12. The rotation apparatus of claim 7, further comprising:
a driving unit configured to provide a driving force such that the tilt member is tilted.
